(19) United States
(12) Patent Application Publication
(10) Pub. No.: US 2026/0335933 A1
(43) Pub. Date: Oct. 29, 2026

(54) Ultrasonic transducer, device with and use of an ultrasonic transducer, and corresponding method

(71) Applicant: JOSEF GMEINER, Weiherhammer (DE)

(72) Inventor: JOSEF GMEINER, Weiherhammer (DE)

(21) Appl. No.: 19/120,525

(22) PCT Filed: Oct. 12, 2023
(86) PCT No.: PCT/EP2023/078404

§ 371 Date: Apr. 11, 2025

(30) Foreign Application Priority Data
Oct. 13, 2022 (DE) 10 2022 126 738.5

(51) Int. Cl. B06B 1/06

(52) U.S. Cl. CPC B06B 1/0648

(57) ABSTRACT

In one aspect, an ultrasonic transducer for generating high-frequency vibrations is formed as a planar single piece with a thickness in a thickness direction, a length in a length direction, and a width in a width direction. The thickness of the ultrasonic transducer is m*λ/2, where m is a natural odd number, and the length (L) is n*λ/2, where n is a natural number greater than or equal to 2, wherein the ultrasonic transducer can be excited, via the initiation of high-frequency mechanical vibrations, to develop one or more thickness vibration(s), which then follow one another in the length direction of the ultrasonic transducer, the thickness vibration(s) having a wavelength λ measured in the length direction and also having vibration amplitudes which are substantially constant in the width direction as viewed over the length of the ultrasonic transducer.

### CROSS-REFERENCE TO RELATED APPLICATIONS

The present application is a U.S. national phase entry of International Patent Application No. PCT/EP2023/078404, filed Oct. 12, 2023, which, in turn, is based upon and claims the right of priority to German Patent Application No. 10 2022 126 738.5, filed Oct. 13, 2022, the disclosures of which are hereby incorporated by reference herein in their entirety for all purposes.

### FIELD OF THE INVENTION

The present subject matter relates to an ultrasonic transducer for generating high-frequency vibrations, wherein the ultrasonic transducer is formed as a planar single piece with a thickness in a thickness direction, a length in a length direction, and a width in a width direction. The present subject matter also relates to a device having such an ultrasonic transducer and to the use of the ultrasonic transducer and to corresponding methods.

### BACKGROUND OF THE INVENTION

Previously, planar ultrasonic transducers have been known primarily for use in cleaning devices. In this connection, a planar ultrasonic transducer is vertically immersed in a cleaning bath, wherein a plurality of ultrasonic converters is mounted on the planar rear face of the ultrasonic transducer facing away from the cleaning bath. The ultrasonic converters cause non-harmonic vibrations in the ultrasonic transducer, which non-harmonic vibrations are transmitted to the water. Due to the therefore permanently generated positive pressure and negative pressure in the water, very small air bubbles form, which swell to a multiple of their original diameter until they burst and release energy, which, for example, removes dirt from surfaces.

The known planar ultrasonic cleaning transducers, which operate predominantly with surface waves, are all matched to one-fourth of the harmonic wavelength λ/4 of the ultrasonic transducers in order to optimize a coupling to the cleaning medium, usually water or predominantly water. The dimensions of known ultrasonic transducers are selected such that the length and the width of the ultrasonic transducers are substantially greater than the thickness of the ultrasonic transducers.

The known ultrasonic transducers are usable only in highly limited applications, however, due to their design. Accordingly, an improved ultrasonic device that addresses one or more of the problems associated with the prior art would be welcomed in the technology.

### SUMMARY OF THE INVENTION

In various aspects, the present subject matter is directed to providing a planar ultrasonic transducer with which new applications can be developed. Additionally, the present subject matter is directed to providing corresponding devices having such an ultrasonic transducer, as well as uses and methods.

In various aspects, the problem(s) associated with the prior art is/are addressed by an ultrasonic transducer (and related devices, uses, and methods) having the features described and claimed herein.

In one aspect, the present subject matter relates to an ultrasonic transducer, wherein the thickness of the ultrasonic transducer is m*λ/2, where m is a natural odd number, and the length is n*λ/2, where n is a natural number 2. When appropriately excited from the outside by means of an ultrasonic converter, which initiates high-frequency mechanical vibrations in the ultrasonic transducer, the ultrasonic transducer according to the present subject matter vibrates in the form of one thickness vibration or multiple thickness vibrations following one another in the length direction of the ultrasonic transducer, wherein the thickness vibrations have the wavelength λ as measured in a length direction of the ultrasonic transducer. In particular, the ultrasonic transducer according to the present subject matter is distinguished by the fact that the vibration amplitudes are substantially constant in the width direction as viewed over the length of the ultrasonic transducer. A wave is therefore formed extending over the width of the ultrasonic transducer, which has a vibration amplitude which is constant in the width direction, extends sinusoidally in the length direction, and is characterized by an expansion and contraction of the local thickness of the ultrasonic transducer.

In other words, peaks and valleys do not alternate along a line in the width direction of the ultrasonic transducer, but rather, substantially, a common wavefront is located along the aforementioned line. As a result, a more uniform energy transmission, which has a higher amplitude, onto, for example, media to be processed, can be achieved, which media are guided past the ultrasonic transducer, for example, in the length direction of the ultrasonic transducer.

The present subject matter therefore relates, for the first time, to matching a planar ultrasonic transducer, at least in terms in thickness and length, to a wavelength at which the ultrasonic transducer vibrates sinusoidally in the form of thickness vibrations, wherein one or more thickness vibration(s) (following one another in the length direction) occur(s). In this way, surprisingly high energies can be emitted from the ultrasonic transducer, which opens up a multitude of possible new applications.

The term “single piece” refers, in the present case, to a coherent unit which does not need to be formed, in particular, by integrally bonding two or more parts, but rather is formed as one single piece, in particular by milling from one single block of a suitable metal.

Advantageously, the ultrasonic transducer according to the present subject matter has a uniform thickness of λ/2. In this case, no nodes form over the thickness of the ultrasonic transducer, which is preferred for many applications.

Particularly preferably, the ultrasonic transducer according to the present subject matter has a width of n*λ/4, where n is a natural number. It turns out that, when such a selection is made, the thickness vibrations and the constant vibration amplitudes in width directions can be optimized.

According to other advantageous embodiments, the width of the ultrasonic transducer is n*λ/2, where n is a natural number and preferably a natural odd number. According to such an embodiment, the width of the ultrasonic transducer is advantageously therefore 1/2*λ or λ or 3/2*λ or 2*λ or 5/2*λ or 3*λ, etc., and preferably 3/2*λ or 5/2*λ or 7/2*λ or 9/2*λ, etc. In particular, given an exact setting of the width of the ultrasonic transducer, it has been shown that nearly pure longitudinal waves arise in the direction of the length direction, or of the length extension, of the ultrasonic transducer.

In certain embodiments, it has proven advantageous that the width of the ultrasonic transducer according to the present subject matter is at least λ.

In certain embodiments which have proven advantageous, the length of the ultrasonic transducer according to the present subject matter is k*λ/2, where k is a natural even number greater than or equal to 2. The length in these cases is therefore λ or 2*λ or 3*λ, etc. It has been shown with respect to such a selection that highly uniform sine waves can be obtained in the direction of the length direction of the ultrasonic transducer. In addition, however, given a length of 3/2*λ, 5/2*λ, 7/2*λ, 9/2*λ, when, i.e., n in the formula n*λ/2 for the length of the ultrasonic transducer is a natural odd number, it is possible to achieve the effect according to the present subject matter, specifically that vibration amplitudes which are substantially constant in the width direction as viewed over the length of the ultrasonic transducer are to be observed. In both cases, the sine waves are superimposed by very low to hardly any amplitude fluctuations in the width direction.

The ultrasonic transducer according to the present subject matter is particularly preferably homogeneous throughout and, in particular, has no slots or fully enclosed recesses. As a result, a uniform excitation of vibrations in the ultrasonic transducer is achieved. Plate transducers in the form of welding sonotrodes are known from the prior art, in which exclusively longitudinal waves are to be emitted from the ultrasonic transducer. Transverse waves are to be suppressed by the aforementioned recesses and/or slots. In the prior art, planar welding sonotrodes result, which vibrate back and forth as a whole, i.e., vibrations do not build up over the plate itself. In the present subject matter, longitudinal waves are also desired, although no slots or recesses are necessary. Rather, in the ultrasonic transducers according to the present subject matter, longitudinal vibrations build up, which extend over the entire plate, i.e., the ultrasonic transducer therefore does not vibrate as a whole back and forth in a planar manner.

For all embodiments according to the present subject matter, it has proven advantageous that one-half the wavelength, i.e., λ/2, is in the range between 90 mm and 120 mm. The excitation frequency at such wavelengths is preferably in the range from 19 kHz to 22 kHz, wherein finding the appropriate excitation frequency cannot be strictly calculated from the formula (frequency=speed of light/wavelength), but rather is to be determined by experimentation or by means of a preceding simulation. At a smaller wavelength λ, a greater excitation frequency must be selected in order to cause harmonic vibrations in the ultrasonic transducer. At λ/2 in the range of 80 mm, the excitation frequency is, for example, approximately 30 kHz, at λ/2 in the range of 50 mm, the excitation frequency is approximately 35 kHz.

An advantageous width of the ultrasonic transducer according to the present subject matter is at least 100 mm and preferably at least 500 mm. Greater widths are readily possible, for example, also widths of at least 1000 mm or 2000 mm or 3000 mm or even greater. Even with these very great widths, the excitation of an ultrasonic transducer according to the present subject matter with high vibration amplitudes has also been achieved in corresponding experiments.

The advantageous lengths of the ultrasonic transducer according to the present subject matter are also in the range from multiple hundreds to multiple thousands of millimeters. It has proven advantageous when the outer dimensions of the ultrasonic transducer are also selected to be smaller at smaller wavelengths λ than at greater wavelengths λ in order to generate an optimal excitation of the ultrasonic transducer, causing harmonic vibrations in the longitudinal direction.

According to advantageous embodiments, the ultrasonic transducer according to the present subject matter is cuboid. It has been shown that, with this simple geometric configuration, ultrasonic transducers having harmonic longitudinal waves with a vibration amplitude which is constant in the width direction and extends sinusoidally in the length direction are possible, with which the energy of the longitudinal waves can be uncoupled from the ultrasonic transducer.

According to other embodiments, it is advantageous when the single-piece ultrasonic transducer has at least one first and one second cuboid portion, wherein these two cuboid portions adjoin each other at the width sides of the cuboid portions and each has a width of a multiple of λ/2. These two cuboid portions are offset with respect to one another in the width direction, as a result of which the first cuboid portion protrudes beyond the second cuboid portion by one cuboid subportion on one side as viewed in the width direction.

On the other side of the ultrasonic transducer, also as viewed in the width direction of the ultrasonic transducer, the relations are reversed, i.e., the second cuboid subportion protrudes beyond the first cuboid subportion. Each of the cuboid subportions protruding in the width direction have a width of λ/4 or of an odd multiple of λ/4. It has proven surprising that, given such a configuration, the vibration peaks and vibration valleys of longitudinal vibrations—which have been excited in the length direction of the ultrasonic transducer—of the one cuboid portion can be largely or completely aligned with the corresponding vibration peaks and vibration valleys of the other cuboid portion, as viewed over the width of the ultrasonic transducer. Therefore, as viewed over the width of the ultrasonic transducer, a largely uniform sinusoidal wavefront is formed in the length direction of the ultrasonic transducer.

Preferably, the at least two cuboid portions are equally wide, so that the two cuboid subportions, which protrude beyond the first and the second cuboid portions, are also equally wide. Preferably, the width of each of the two cuboid subportions is λ/4.

According to an alternative of an arrangement of the cuboid portions, which is offset in the width direction, provided that the configuration of the ultrasonic transducer is otherwise the same, one of the two cuboid portions protrudes beyond the adjoining cuboid portion at each of the two ends of the cuboid portion in the width direction by one cuboid subportion in each case. Each of the two cuboid subportions of the cuboid portions protruding in the width direction have a width of λ/4 or of an odd multiple of λ/4. The advantage of the wavefront, which is uniform over the width of the ultrasonic transducer, that is obtained in the above-described embodiment is also realized in this embodiment.

Advantageously, the length of each cuboid portion is λ/2 or a multiple of λ/2. This embodiment allows for precisely matching the vibration waves propagating in the length direction of the ultrasonic transducer.

Further preferably, the at least two cuboid portions are of equal length.

According to one development of the above-described embodiments, the ultrasonic transducer consists of multiple block portions following one another in the length direction, wherein each block portion is formed of at least two of the aforementioned cuboid portions. Due to this measure, a greater working length is achieved, for example, when guiding material webs to be processed by the ultrasonic transducer along the length direction of the ultrasonic transducer.

A preferred material for the ultrasonic transducer according to the present subject matter is aluminum. The single-piece planar ultrasonic transducer is then preferably milled from one single aluminum block.

Alternative materials for the ultrasonic transducer are steel, a steel alloy, or titanium. In this case as well, the ultrasonic transducer is preferably produced by milling.

The present subject matter also relates to a device for generating high-frequency vibrations, which device has at least one ultrasonic converter and at least one ultrasonic transducer, as described above, wherein the ultrasonic transducer is connected to the at least one ultrasonic converter. The ultrasonic converter can be, in particular, an electromechanical (e.g., piezoelectric or magnetoresistive) energy converter. The ultrasonic transducer can then be used, in particular, as an ultrasonic tool. The converter is used to transform electrical AC voltages into mechanical alternating strains and, in this way, to excite structural vibrations in the mechanically coupled ultrasonic transducer, which then transmits the vibrations of the ultrasonic transducer to a tool which has been connected to the ultrasonic transducer.

In addition, a booster can be advantageously located between the ultrasonic converter and the ultrasonic transducer, with which amplitude can be transmitted from the ultrasonic converter to the ultrasonic transducer. Both the ultrasonic converter and the booster are widely known from the prior art.

Particularly advantageously, the at least one ultrasonic converter is coupled from the top side or from the underside to the at least one ultrasonic transducer. The ultrasonic converter is preferably coupled in a node (which, after one half vibration, becomes an antinode) of the ultrasonic transducer, in order to achieve an optimal energy input.

Preferably, the at least one ultrasonic converter is coupled to the ultrasonic transducer at a distance of λ/4 or of a multiple of λ/4 to the width edge extending in the width direction and also to the length edge of the ultrasonic transducer extending in the length direction. It has been shown that such a connection point for the ultrasonic converter to the ultrasonic transducer enables an optimal excitation of vibrations. At a distance of λ/4, or of a multiple of λ/4, from the width edge, the ultrasonic converter couples to a point on the ultrasonic transducer, which vibrates with a maximum displacement amplitude.

Particularly preferably, for the purpose of exciting the aforementioned longitudinal waves, only one single ultrasonic converter is coupled from the top side or the underside to the ultrasonic transducer. Such an embodiment stands in contrast, in particular, to ultrasonic cleaning transducers, in which a plurality of ultrasonic converters is coupled to one side of the ultrasonic transducer, usually on the side facing away from the cleaning bath.

According to advantageous embodiments, the at least one ultrasonic transducer is coupled to a device which covibrates in the thickness direction of the ultrasonic transducer, which device can be an embossing tool, a stamp, or an erosion tool. Due to the high amplitudes to be achieved by means of the present subject matter as well as the high energy output to a workpiece to be processed, a high efficiency can be achieved by means of a device which has been designed in this way.

In order to process planar workpieces such as material webs, a transport mechanism is preferably associated with the underside or the top side of the at least one ultrasonic transducer, which transport mechanism enables at least one material web to be guided through the device and, in particular, to be guided between the ultrasonic transducer and the transport mechanism. The transport mechanism preferably includes one or more actively and/or passively driven roller(s), or roll(s). According to one alternative, a removal mechanism is provided downstream from the ultrasonic transducer, wherein a counterplate is associated with the top side or the underside of the ultrasonic transducer in order to guide one or more material web(s) between the ultrasonic transducer, which is acting as a working tool, and the counterplate.

The present subject matter further relates to the use of an above-described ultrasonic transducer for a device or for an above-described device.

The present subject matter also relates to a method for operating an above-described device, wherein the method is used to connect at least two material webs, to reinforce, to dry, to emboss or smooth at least one material web, to heat, to filter, to separate materials, to clean sewage sludge, and/or to convert mechanical energy into electrical energy, in particular by means of piezoelectric transducers.

A method according to the present subject matter is distinguished by the fact that a planar complete web consists of multiple material webs, which are interconnected by means of a device according to the present subject matter. The interconnection is preferably carried out by continuously transporting the complete web through the device in the length direction of the ultrasonic transducer. The length direction of the ultrasonic transducer therefore corresponds to the transport direction of the complete web. For example, an adhesive is applied onto one of the material webs, over the entire surface or only in areas, advantageously in a pattern, whereupon the complete web is guided between the underside or the top side of the ultrasonic transducer and a pressing countertool, in particular actively or passively driven rollers or rolls. When passive rollers or rolls are provided, which are located opposite the ultrasonic transducer, the complete material web can be pulled through the device, for example, by downstream removal rollers. Due to the high energy input, including the great vibration amplitude, which can be coupled in by the ultrasonic transducer, the adhesive is optimally melted and the material webs are interconnected by the pressure to form one complete web. The longer the ultrasonic transducer is (i.e., the longer the transport route is along the ultrasonic transducer), the greater is the working length and the more uniformly and reliably can the material webs be connected.

Advantageous developments are characterized by the features of the dependent claims.

### BRIEF DESCRIPTION OF THE FIGURES

The invention shall be explained in greater detail below with reference to figures, in which identically designed and/or identically acting features are provided with the same reference characters. Wherein:

FIGS. 1a-1c show a top view, a side view, and a front view of a first embodiment of an ultrasonic transducer according to the present subject matter;

FIG. 2 shows a front view of the ultrasonic transducer shown in FIG. 1 with connected ultrasonic excitation devices;

FIGS. 3a, 3b show a simulated thickness vibration of a second embodiment of an ultrasonic transducer at a first point in time and at a second point in time;

FIGS. 4a, 4b show a simulated thickness vibration of a third embodiment of an ultrasonic transducer at a first point in time and at a second point in time;

FIGS. 5a-5c show a top view, a side view, and a front view of a fourth embodiment of an ultrasonic transducer according to the present subject matter;

FIG. 6 shows a front view of the ultrasonic transducer shown in FIG. 5 with connected ultrasonic excitation devices;

FIGS. 7a-7d show a top view, a side view, a front view, and a perspective top view of a fifth embodiment of an ultrasonic transducer according to the present subject matter;

FIGS. 8a, 8b show a simulated thickness vibration of a sixth embodiment of an ultrasonic transducer at a first point in time and at a second point in time;

FIGS. 9a, 9b show a simulated thickness vibration of the sixth embodiment according to FIGS. 8a, 8b at two points in time, shown with a connected booster;

FIG. 10 shows a top view of a seventh embodiment of an ultrasonic transducer;

FIG. 11 shows a top view of an eighth embodiment of an ultrasonic transducer:

FIG. 12 shows a top view of a ninth embodiment of an ultrasonic transducer;

FIG. 13 shows a side view of the ultrasonic transducer shown in FIG. 1 with tools arranged on the underside and downstream removal rollers;

FIG. 14 shows a side view of the ultrasonic transducer shown in FIG. 7 with transport rollers arranged on the underside, and

FIG. 15 shows a side view of the ultrasonic transducer shown in FIG. 7 with a counterpressure plate arranged on the underside and downstream removal rollers.

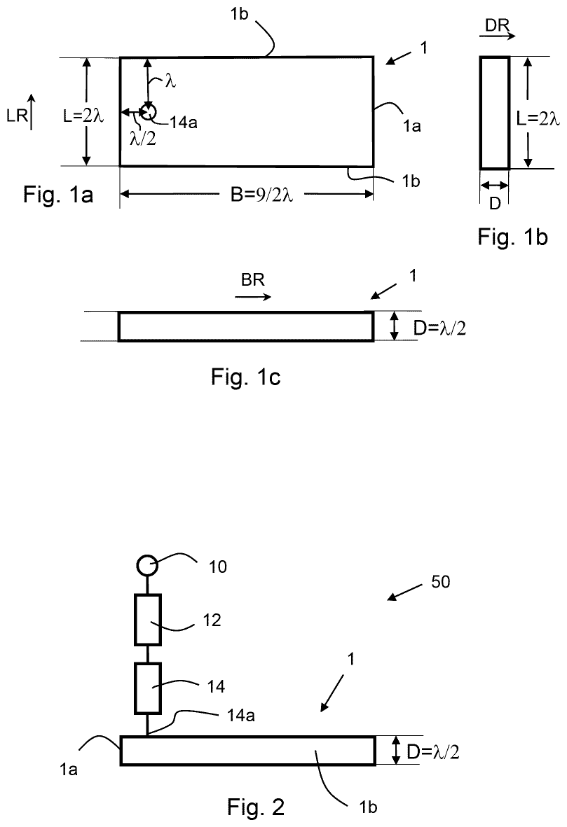

FIGS. 1a-1c show an ultrasonic transducer 1 according to the present subject matter in a top view, a side view, and a front view. The ultrasonic transducer 1 is made of a piece of metal in the form of a cuboid, preferably being made of aluminum and, according to advantageous alternatives, of steel or titanium. The ultrasonic transducer does not have any slots or fully enclosed recesses, which are used in the prior art, in particular, for suppressing transverse waves. In the ultrasonic transducer 1 according to the present subject matter, however, in this regard, no vibration behavior-disturbing transverse waves occur, due to the fundamentally different geometric configuration of the ultrasonic transducer, in particular due to the thickness being matched to one-half the wavelength λ/2.

The ultrasonic transducer 1 has a thickness D in the thickness direction DR, a length L in the length direction LR, and a width B in the width direction BR. In the present case, the thickness D of the ultrasonic transducer 1 shown in FIG. 1 is λ/2 and the length L is 2*λ. In general, according to the present subject matter, the thickness D is m*λ/2, where m is a natural odd number, and the length (L) is n*λ/2, where n is a natural number greater than or equal to 2. The width B of the ultrasonic transducer 1 shown in FIG. 1 is 9/2*λ. The aforementioned wavelength λ is considered in the length direction LR of the ultrasonic transducer 1. λ is the wavelength at which the ultrasonic transducer 1—when appropriately excited—is able to vibrate harmonically in the form of a longitudinal wave, which appears as thickness vibrations (see also below).

All dimensions of the ultrasonic transducer 1 shown in FIG. 1 are based, as mentioned above, on one-half the wavelength λ/2 or on a multiple of λ/2, specifically, the thickness D is based on λ/2, the length L is based on 2*λ, and the width B is based on 9/2*λ.

The aforementioned wavelength λ is preferably between 180 mm and 240 mm, so that λ/2 is therefore between 90 mm and 120 mm. The width B of the ultrasonic transducer is advantageously at least 100 mm, preferably at least 500 mm, for example, at least 1000 mm or at least 2000 mm.

FIG. 2 shows a device 50 having an ultrasonic transducer 1 and an ultrasonic converter 12 connected to the ultrasonic transducer 1, which ultrasonic converter is connected to a voltage supply 10. Moreover, in the present case, a booster 14 is connected between the ultrasonic converter 12 and the ultrasonic transducer 1 in order to amplify the amplitude provided by the converter 12 and convey this to the ultrasonic transducer 1. Such a booster 14 is optional, however, and, thus, does not necessarily need to be present.

The excitation frequency is advantageously selected in the range between 19 kHz and 22 kHz for a wavelength λ in the range from 90 mm and 120 mm, specifically such that the harmonic vibrations according to the present subject matter set in.

The booster 14 is coupled to the ultrasonic transducer 1 at the connection point 14a (see also FIG. 1a), which is spaced apart from the length edge 1a of the ultrasonic transducer (i.e., the edge of the ultrasonic transducer 1 extending in the length direction LR) by λ/2 and from the width edge 1b of the ultrasonic transducer (i.e., the edge of the ultrasonic transducer 1 extending in the width direction BR) by λ. In general, the distance from the connection point 14a to the width edge and to the length edge is selected to be λ/4 or a multiple thereof in each case.

Preferably, the device 50 includes only one single ultrasonic converter 12, which is coupled—via the booster 14 in this case—to the top side of the ultrasonic transducer 1 (or alternatively to the underside of the ultrasonic transducer).

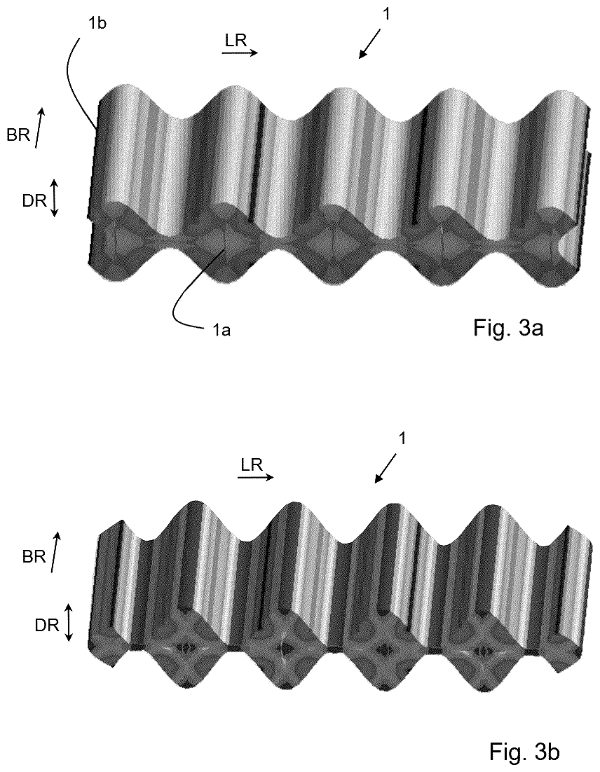

The ultrasonic transducers 1 according to the present subject matter vibrate in the form of thickness vibrations having vibration amplitudes which are substantially constant in the width direction BR as viewed over the length L of the ultrasonic transducer 1. These vibration features are apparent, for example, in FIGS. 3a and 3b, in which the thickness vibrations of a second embodiment of an ultrasonic transducer 1 are shown at two different points in time in a three-dimensional computer simulation. In this simulation, the thickness D of the ultrasonic transducer 1 was set at λ/2, the length was set at 9/2*λ, and the width was set at 2*λ+5%. As is apparent in FIGS. 3a and 3b, there are no nodes in the width direction BR; the vibration amplitude is substantially the same size in the width direction BR for each length portion (along the length direction LR). The number of vibrations in the length direction LR is in accordance with the selected length L 4.5*λ, or 9/2*λ, of the ultrasonic transducer.

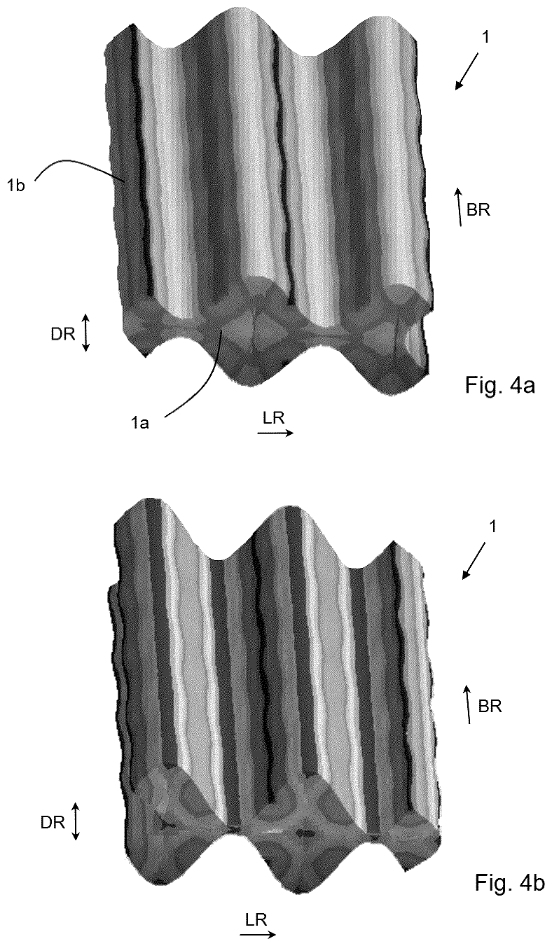

FIGS. 4a and 4b show, in a computer simulation, a third embodiment of an ultrasonic transducer 1 according to the present subject matter having a thickness of λ/2, a length L of 3/2*λ, and a width of 9/2*λ. It is apparent here as well—on the basis of two different points in time by way of example—that, when the ultrasonic transducer is excited in the length direction LR, thickness vibrations, which are also referred to as harmonic longitudinal waves extending in the length direction LR, are excited, in which the respective amplitude is substantially constant in the width direction BR.

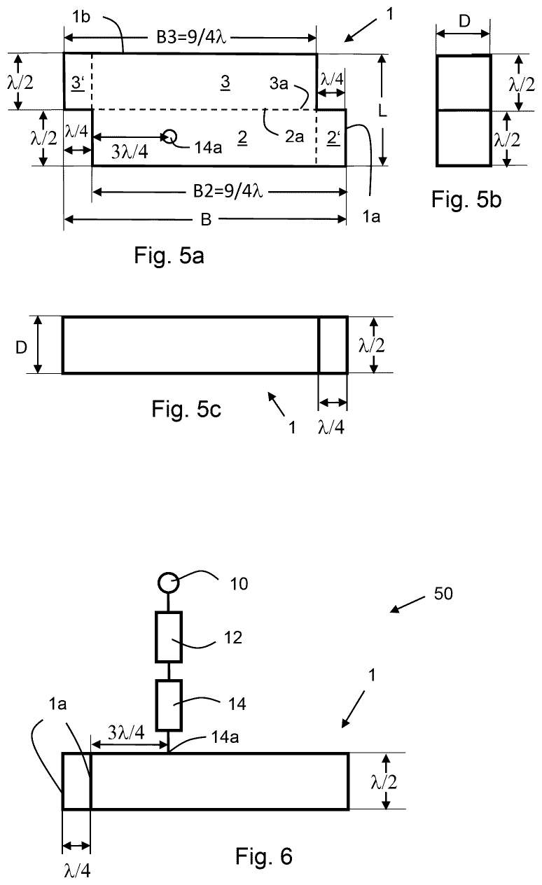

A fourth embodiment of an ultrasonic transducer 1 according to the present subject matter is shown in FIGS. 5a-5c. This ultrasonic transducer 1 has a first and a second cuboid portion 2, 3, which integrally adjoin each other at the mutually facing width sides 2a, 3a of the cuboid portions and each have a width B2 and B3, respectively. These two widths B2 and B3 are each 9/4*λ in this case (in general: (n*λ/2+λ/4), where n is a natural number). The distinctive feature here is that the two cuboid portions 2, 3 are offset with respect to one another in the width direction BR, wherein the cuboid subportions 2′, 3′, each of which protrudes in the width direction BR, have a width B2, B3 of λ/4 (in general: m*λ/4, where m is a natural odd number). The two widths B2, B3 do not need to be identical, although they are in the present case. The overall width B of the ultrasonic transducer 1 is therefore 5/2*λ. The length of the two cuboid portions 2, 3 is λ/2 in each case, so that the length L of the ultrasonic transducer 1 is λ.

FIG. 6 shows, similarly to FIG. 2, a coupling of an ultrasonic converter 12, which is connected to a voltage source 10, to a connection point 14a on the ultrasonic transducer 1, with a booster 14 being connected between the ultrasonic converter and the ultrasonic transducer. The connection point 14a is located 3/4*λ away from the length edge of the cuboid portion 2. The selected distance from the connection point 14a to the width edge and to the length edge is λ/4 or a multiple thereof in each case.

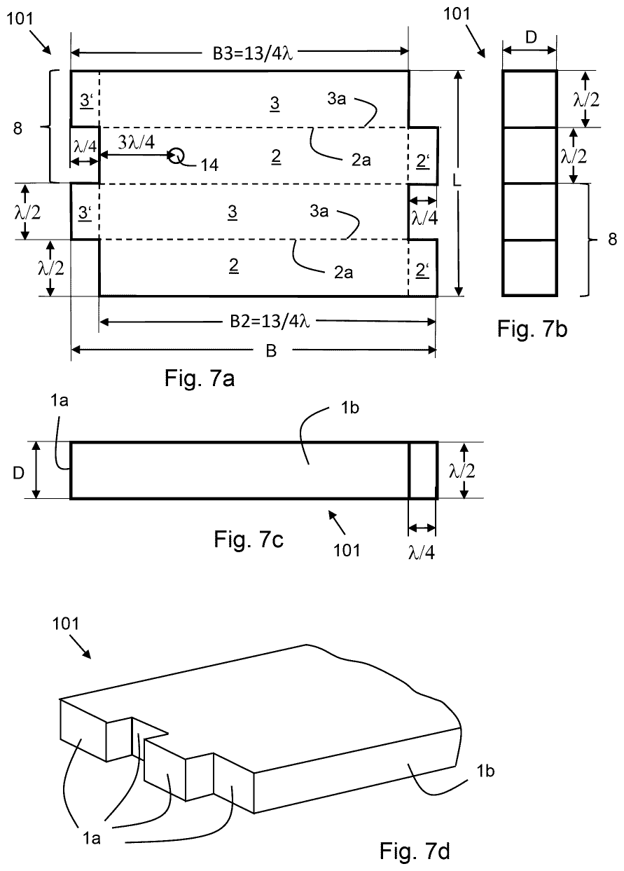

FIGS. 7a-7d show a fifth embodiment of an ultrasonic transducer 101 according to the present subject matter. Two block portions 8 are arranged one behind the other in the length direction LR, each block portion 8 consisting of an ultrasonic transducer 1 according to FIG. 7a having two cuboid portions 2, 3 in each case. Two such block portions 8 adjoin each other in the length direction LR in the embodiment shown in FIG. 7b. The ultrasonic transducer 101 according to FIG. 7 also has the vibration behavior according to the present subject matter in the thickness direction, i.e., in particular, the absence of nodes in the width direction BR.

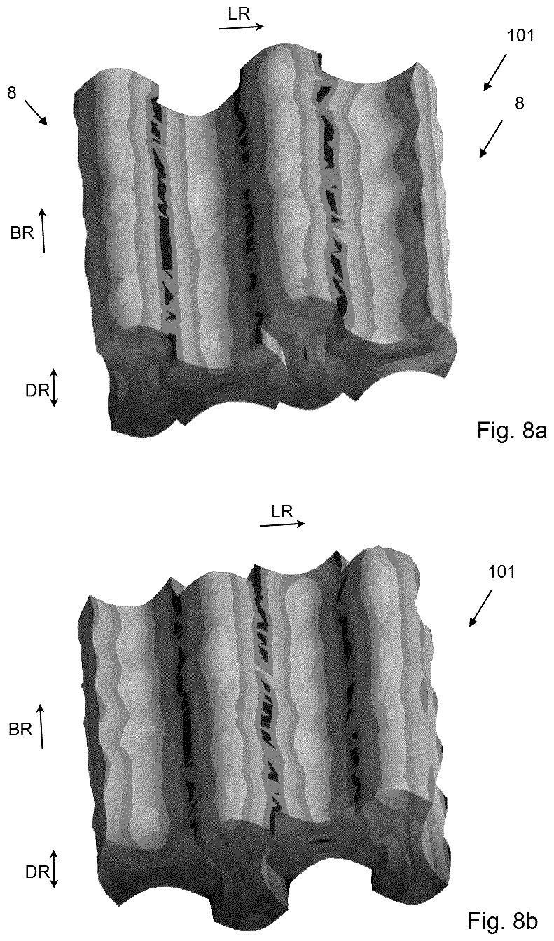

FIGS. 8a and 8b show, in a three-dimensional computer simulation, the thickness vibrations of a sixth embodiment of an ultrasonic transducer 101 at two different points in time. The ultrasonic transducer 101 shown in FIGS. 8a and 8b is basically configured the same as the ultrasonic transducer shown in FIGS. 7a-7d, i.e., it also consists of two block portions 8. In this ultrasonic transducer 101, the thickness D was set at λ/2, the length L was set at 2*λ, and the width B was set at 9/2*λ. As mentioned above with reference to the embodiments shown in FIGS. 3 and 4, there are no nodes in the width direction BR in FIGS. 8a and 8b, i.e., the vibration amplitude is substantially the same size in the width direction BR at each point along the length direction LR. The number of vibrations in the length direction LR is in accordance with the selected length L of the ultrasonic transducer 2*λ.

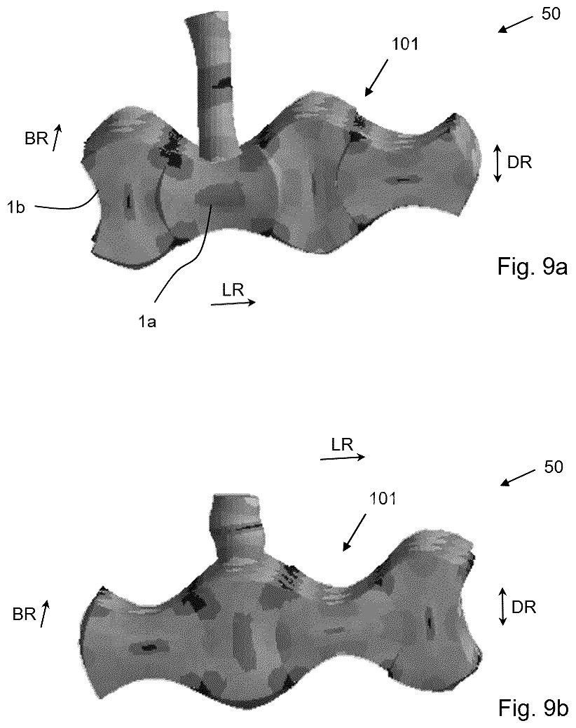

FIGS. 9a and 9b show, in a slightly perspective view, the ultrasonic transducer 101 shown in FIGS. 8a and 8b with a connected booster 14. It is apparent that the booster 14 is connected at a connection point 14a on the ultrasonic transducer 101, which ultrasonic transducer has the maximum vibration amplitude (cf. FIG. 9a and FIG. 9b).

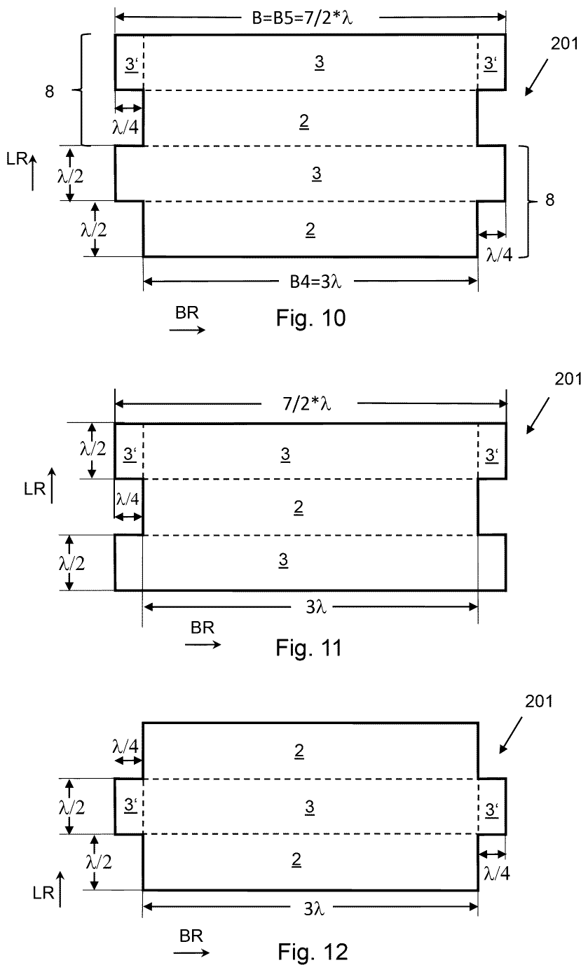

FIGS. 10-12 show a seventh, an eight, and a ninth embodiment of an ultrasonic transducer 201 according to the present subject matter. The seventh embodiment shown in FIG. 10 consists of two identical block portions 8, which follow one another in the length direction LR and are interconnected in the width direction BR, wherein each block portion 8 is formed of two cuboid portions 2, 3 (cf. FIG. 7). The difference from the embodiment shown in FIG. 7 is that the two cuboid portions 2, 3 have a respective width B4, B5 of n*λ/2, where n is a natural number, wherein the two ends of the cuboid portion 3 protrude beyond the adjacent cuboid portion 2 in the width direction by one cuboid subportion 3′ at each end, which cuboid subportion has the width λ/4 (in general m*λ/4, where m is a natural odd number). The length of each cuboid portion 2, 3 is λ/2 and, therefore, the overall length of the ultrasonic transducer 201 is 2*λ, whereas the width B of the ultrasonic transducer corresponds to the width B5 and, therefore, is 7/2*λ. The thickness D of the ultrasonic transducer 201 is, for example, λ/2, which is preferred, or 3/2*λ.

An ultrasonic transducer according to the present subject matter which is not shown here can also consist of only one block portion 8 of the type shown in FIG. 10.

The eighth embodiment of an ultrasonic transducer 201 according to the present subject matter, which is shown in FIG. 11, has three cuboid portions 3, 2, 3, wherein the front and the rear—as viewed in the length direction LR—cuboid portions 3 are identically designed. Each of the two ends of the two cuboid portions 3 protrudes beyond the central cuboid portion 2 in the width direction BR by one cuboid subportion 3′ at each end, which cuboid subportion has the width λ/4 (in general m*λ/4, where m is a natural odd number). The length of each cuboid portion 2, 3 is λ/2 in the present case and, therefore, the overall length of the ultrasonic transducer 201 is 3/2*λ, whereas the overall width B of the ultrasonic transducer is 7/2*λ. The thickness D of the ultrasonic transducer 201 is, for example, λ/2 or 3/2*λ.

The ninth embodiment of an ultrasonic transducer 201 according to the present subject mater, which is shown in FIG. 12, also has three cuboid portions 2, 3, 2, which integrally adjoin each other, wherein the front and the rear—as viewed in the length direction LR—cuboid portions 2 are identically designed. Each of the two ends of the central cuboid portion 3 protrudes beyond the two cuboid portions 2 in the width direction BR by one cuboid subportion 3′ at each end, which cuboid subportion has the width λ/4 (in general m*λ/4, where m is a natural odd number). The length of each cuboid subportion 2, 3 is λ/2 in the present case and, therefore, the overall length of the ultrasonic transducer 201 is 3/2*λ, whereas the overall width B of the ultrasonic transducer is 7/2*λ. The thickness D of the ultrasonic transducer 201 is, for example, λ/2 or 3/2*λ.

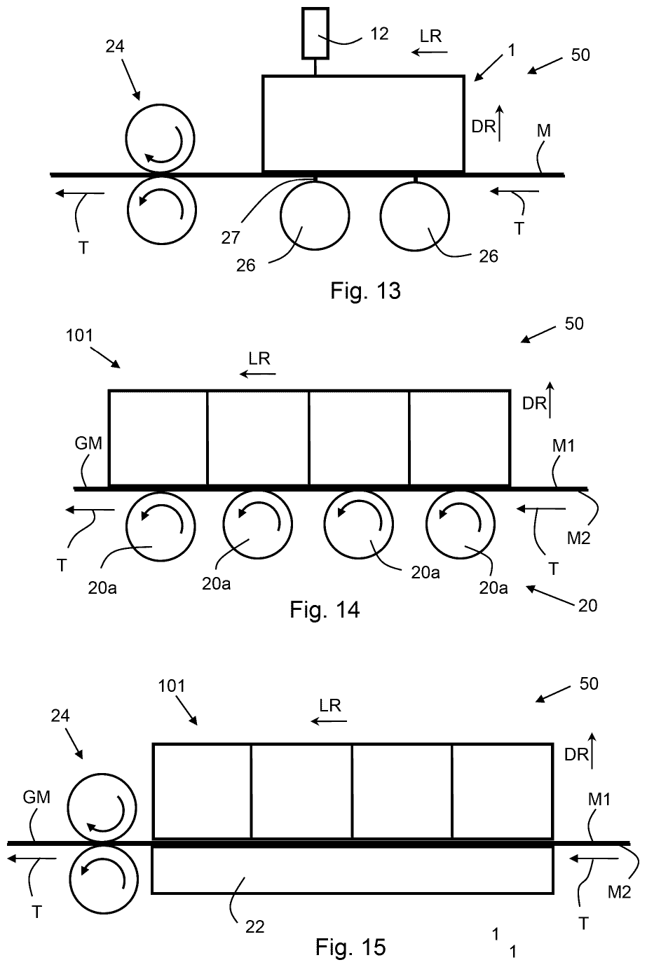

In FIG. 13, an ultrasonic transducer 1, which is connected to an ultrasonic converter 12 and is designed in this case according to FIG. 1, is arranged opposite two tools 26 (the voltage source 10 and, optionally, the booster 14, are not shown), which are fixed in place, wherein this tool 26 terminates, for example, in an embossing tool, a stamp, an erosion tool, or one or more welding tip(s) or edge(s). In the present case, the free end of each of the two tools 26 is a stamp 27 and faces the underside of the ultrasonic transducer 1. A material web M is guided in the transport direction T between the ultrasonic transducer 1 and the two tools 26, processed there by means of the stamp 27, and removed from this work zone by a pair of downstream removal rollers 24. By means of this pair of removal rollers 24, the guidance of the material web M along the entire device 50 is also realized.

FIG. 14 shows a device 50 for connecting two material webs M1 and M2. An ultrasonic transducer 101 according to the present subject matter, which is designed according to FIG. 7 in the present case, is excited to vibrate (by means of an ultrasonic converter 12, which is not shown) in the thickness direction, as is shown, for example, in FIGS. 3a, 3b. The counter-tool used is a transport mechanism 20 in the present case, which transport mechanism consists of four transport rollers 20a arranged one behind the other in the transport direction T, which transport rollers perform two functions. In one function, the ultrasonic transducer 101 initiates vibrations in the two material webs M1, M2 at each transport roller 20a and under the effect of the counterpressure of each transport roller, and welds the material webs together; in another function, the transport rollers 20a are also used to actively guide the two material webs M1, M2 and the resultant complete web GM through the device.

In FIG. 15, a counterplate 22 forms a tool, which extends over the entire length of the ultrasonic transducer 101, which in this case is designed similarly to the embodiment shown in FIG. 7. Holes can also be present in the counterplate 22 (perforated metal plate), so that steam or liquids can escape from the space between the ultrasonic transducer 101 and the counterplate 22. Therefore, two material webs M1, M2 supplied one above the other can be welded together over a very great length to form one complete web GM, which in turn is drawn off by a pair of removal rollers 24 in the present case.

Correspondingly equipped devices according to the present subject matter can be used, in particular, to connect at least two material webs, to reinforce, to dry, in particular to dry glue or adhesive, to emboss or smooth at least one material web, to heat, filter, to separate materials, to split chemical compounds, to clean sewage sludge, to separate sewage sludge, and to convert mechanical energy into electrical energy, in particular by means of piezoelectric transducers.

Reference characters

| | |
|---|---|
| 1 | ultrasonic transducer |
| 1a | length edge |
| 1b | width edge |
| 2 | first cuboid portion |
| 2′ | first cuboid subportion |
| 2a | width side |
| 3 | second cuboid portion |
| 3′ | second cuboid subportion |
| 3a | width side |
| 8 | block portion |
| 10 | voltage supply |
| 12 | ultrasonic converter |
| 14 | booster |
| 14a | connection point for the ultrasonic converter or the booster |
| 20 | transport mechanism |
| 20a | transport rollers |
| 22 | counterplate |
| 24 | pair of removal rollers |
| 26 | tool |
| 27 | stamp |
| 50 | device |
| 101 | ultrasonic transducer |
| 201 | ultrasonic transducer |
| L | length of the ultrasonic transducer |
| LR | length direction |
| B | width of the ultrasonic transducer |
| BR | width direction |
| D | thickness of the ultrasonic transducer |
| DR | thickness direction |
| M | material web |
| M1 | first material web |
| M2 | second material web |
| GM | complete web |
| T | transport direction |

1-26. (canceled)

27. A An ultrasonic transducer for generating high-frequency vibrations, wherein the ultrasonic transducer is formed as a planar single piece with a thickness in a thickness direction, a length in a length direction, and a width in a width direction, wherein the thickness of the ultrasonic transducer is m*λ/2, where m is a natural odd number, and the length is n*λ/2, where n is a natural number greater than or equal to 2, wherein the ultrasonic transducer can be excited, via the initiation of high-frequency mechanical vibrations, to develop one or more thickness vibration(s), which then follow one another in the length direction of the ultrasonic transducer, the thickness vibration(s) having a wavelength λ measured in the length direction and also having vibration amplitudes which are substantially constant in the width direction as viewed over the length of the ultrasonic transducer.

28. The ultrasonic transducer of claim 27, wherein the thickness of the ultrasonic transducer is λ/2.

29. The ultrasonic transducer of claim 27, wherein the width of the ultrasonic transducer is n*λ/4, where n is a natural number.

30. The ultrasonic transducer of claim 27, wherein the width of the ultrasonic transducer is n*λ/2, where n is a natural odd number.

31. The ultrasonic transducer of claim 27, wherein the width of the ultrasonic transducer is at least a.

32. The ultrasonic transducer of claim 27, wherein the ultrasonic transducer is continuously formed as a block without slots or fully enclosed recesses.

33. The ultrasonic transducer of claim 27, wherein λ/2 is in the range between 90 mm and 120 mm.

34. The ultrasonic transducer of claim 27, wherein the width of the ultrasonic transducer is at least 100 mm.

35. The ultrasonic transducer of claim 27, wherein the ultrasonic transducer is cuboid.

36. The ultrasonic transducer of claim 27, wherein the ultrasonic transducer comprises a first cuboid portion and a second cuboid portion, wherein the first and second cuboid portions integrally adjoin each other at mutually facing width sides of the first and second cuboid portions and each have a width, for each of which (n*λ/2+λ/4) applies, where n is a natural number, wherein the first and second cuboid portions are offset with respect to one another in the width direction forming protruding first and second cuboid subportions, and wherein the first and second cuboid subportions have a width of m*λ/4, where m is a natural odd number.

37. The ultrasonic transducer of claim 27, wherein the ultrasonic transducer comprises a first cuboid portion and a second cuboid portion, wherein the first and second cuboid portions integrally adjoin each other at mutually facing width sides of the first and second cuboid portions and each have a width of n*λ/2, where n is a natural number, wherein two ends of one of the first and second cuboid portions protrude beyond the other of the first and second cuboid portions in the width direction by one cuboid subportion at each end, and wherein each of the cuboid subportions protruding in the width direction has a width of m*λ/4, where m is a natural odd number.

38. The ultrasonic transducer of claim 37, wherein the ultrasonic transducer comprises multiple block portions, which follow one another in the length direction, wherein each block portion is formed of at least two of the first and second cuboid portions.

39. The ultrasonic transducer claim 27, wherein the ultrasonic transducer is formed from aluminum.

40. The ultrasonic transducer of claim 27, wherein the ultrasonic transducer is formed from steel, a steel alloy, or titanium.

41. A device for generating high-frequency vibrations, comprising at least one ultrasonic converter and comprising at least one ultrasonic transducer configured in accordance with claim 27, wherein the at least one ultrasonic transducer is coupled to the ultrasonic converter.

42. The device of claim 41, wherein the at least one ultrasonic converter is coupled to the at least one ultrasonic transducer at a distance of λ/4 or a multiple of λ/4 away from a width edge of the at least one ultrasonic transducer, which extends in the width direction, and from a length edge of the at least one ultrasonic transducer, which extends in the length direction.

43. The device of claim 41, wherein the at least one ultrasonic converter is coupled from a top side or an underside to the at least one ultrasonic transducer.

44. The device of claim 41, wherein one single ultrasonic converter is coupled from a top side or an underside to one single ultrasonic transducer.

45. The device of claim 41, wherein the at least one ultrasonic transducer is coupled to a tool and is arranged opposite a counter-tool, which is fixed in place, wherein the tool vibrates together with the at least one ultrasonic transducer in the thickness direction and thus in the direction of the counter-tool, wherein the tool is selected from the following group: embossing tool, welding tip(s), welding edge, stamp, or erosion tool.

46. The device of claim 45, wherein the tool of is arranged in a node of the at least one ultrasonic transducer, as viewed in the length direction of the at least one ultrasonic transducer, or the tool is arranged opposite a node of the least one ultrasonic transducer, as viewed in the length direction of the at least one ultrasonic transducer.

47. The device of claim 41, wherein the at least one ultrasonic transducer is arranged opposite a tool, which is fixed in place, wherein the tool comprises, on a free end of the tool, a processing device from the following group: embossing tool, welding tip(s), welding edge, stamp, or erosion tool.

48. The device of claim 41, wherein an underside or a top side of the at least one ultrasonic transducer is assigned a transport mechanism.
